(19) United States
(12) Patent Application Publication
(10) Pub. No.: US 2007/0100655 A1
(43) Pub. Date: May 3, 2007

(54) REAL ESTATE TRANSACTION METHOD

(76) Inventors: Steve Siverson, Scottsdale, AZ (US); Daniel Thomas Marmo, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/556,786

(22) Filed: Nov. 6, 2006

Related U.S. Application Data
(63) Continuation-in-part of application No. 11/053,980, filed on Feb. 8, 2005.
(60) Provisional application No. 60/543,375, filed on Feb. 9, 2004.

(51) Int. Cl. G06Q 99/00

(52) U.S. Cl. 705/1

(57) ABSTRACT

A method of selling and promoting real estate is disclosed whereby a home improvement service provider loans money to a property seller to enable the property seller to improve her home prior to sale. The improvements are completed by the home improvement service provider and the loan is paid back when the property sells. Since the property has been improved, it sells for a higher price than it would without the improvements and in a shorter time frame than un-improved properties.

### CROSS-REFERENCE TO RELATED APPLICATIONS

This application is a continuation-in-part of U.S. patent application Ser. No. 11/053,980, filed on Feb. 8, 2005, and entitled “Real Estate Transaction Method” which claims the benefit of U.S. Provisional Patent Application No. 60/543,375 filed on Feb. 9, 2004, both of these applications are incorporated in their entirety by reference.

### FIELD OF THE INVENTION

This invention relates to method of selling real estate. This invention relates particularly to a method of loaning a property seller with money to redecorate and renovate a property prior to sale without bearing the cost of the redecoration and renovation until after the property sells.

### BACKGROUND OF THE INVENTION

When selling a home, most homeowners contact a real estate agent to handle the transaction. Real estate agents usually are independent sales people who provide their services to a licensed real estate broker on a contract basis. In return, the broker pays the agent a portion of the commission earned from the agent's sale of the property. Brokers are independent businesspeople who sell real estate owned by others; they also may rent or manage properties for a fee. A license is required in every state and the District of Columbia to be a real estate broker or agent; however the owner of the real estate brokerage does not necessarily have to be licensed. Instead, a person or persons without a real estate license can form a brokerage and employ a licensed broker to do the work. Licensed agents and brokers and the brokerages that employ them are referred to collectively herein as “real estate professionals.”

The real estate professional is qualified to conduct a number of services as the property owner's agent, including preparing a description of the home, listing the home on a computerized database of homes for sale (referred to as a multiple-listing service or “MLS”), showing the home to potential homebuyers, and preparing documents related to the sale. Prior to listing the home, a real estate professional will require the seller to sign a contract that requires the seller to pay the real estate professional a commission upon the sale of the home, the payment typically triggered by the sale of the home. In some states, the commission payment is triggered upon providing a “ready, willing and able” buyer or the like, regardless of whether the owner sells or refuses to sell. The agreement is known in the art as a “listing agreement.” This listing agreement is officially between the broker and the seller, although the real estate agent typically effects the execution of the agreement with the seller. That real estate professional is considered the “listing agent” and is typically specified as such on the listing agreement. The broker receives a sales commission when the property sells and pays a portion of it to the listing agent. A similar process is undertaken for commercial buildings, empty lots and other unimproved land. Collectively the real property and improvements thereon are referred to herein as the “property.”

By improving the appearance and condition of the property, the property will usually sell sooner and for a higher price. For example, a home that is well-landscaped presents better to a buyer, and therefore typically sells more quickly and for a higher price than one that is poorly landscaped. Similarly, an unfurnished home is more difficult to sell than one that is furnished. However, it is common for the homeowner to have moved her furniture out of the home, before the home is sold, for example, to move the furniture into the seller's new home. Alternatively, in homes newly-built by property developers, the home might not be furnished before it is shown for sale. As another example, an unimproved lot in an area zoned for residential will sell for less than one that has utilities and roads installed.

In the high-end real estate market, it is known in the art to hire interior designers to furnish and decorate a home on behalf of a homeowner before putting the home up for sale. This process is referred to as “staging” a home. The interior designer is paid for the service of designing the decor as well as for the materials used to decorate the home. Conventionally, the interior designer is paid upon completion of staging the home. This creates a heavy financial burden for the seller, however, who is often in the midst of financing a new home herself and who would prefer to preserve cash flow. Historically, staging has been used especially for new luxury homes offered by the home builder and for second homes of well-to-do buyers.

Recently, a new type of real estate investing has become popular in which a person buys a home in a state of disrepair (a “fixer-upper”), quickly renovates and decorates the home, and then sells it after, hopefully, a very short period of time. This type of real estate investing is known as “flipping” properties. This type of investment can be financially burdensome on the investor/owner for at least a short period of time, while significant cash is used to pay a down payment on the loan and to pay to renovate and decorate. Whether a high-end home or starter home, life-long owner or investor, it would be desirable to provide property-improvement services to the property owner to improve the salability of the property, without burdening the property owner with additional expenses. It would also be desirable to provide a solution in which the owner can improve the property prior to sale and reap the financial gain than to sell the property in a state of disrepair to an investor or other buyer who reaps the financial gain.

Banks and other financial institutions may lend money to the property seller for property improvement, but this places the financial burden on the seller just at the time he is trying to avoid additional financial burdens. Further, obtaining a loan from a bank or financial institution is generally a cumbersome application and approval process, which commonly involves providing copies of tax returns, filing out many forms, getting an appraisal, responding to the underwriter's questions, etc. In addition, because that type of lender may not be as familiar with property values and improvements as a real estate professional, another burden is placed on the property owner to determine which improvements should be made, to find and select the appropriate service providers, as well as to determine what a reasonable price is. It would be more desirable to avoid financial burden on the seller during the improvement and sales period.

Good real estate professionals are familiar with many property-improvement services and service providers that make properties more enticing, whereas the property owner may not be. A real estate professional having this expertise would have a competitive advantage over other real estate agents by providing property improvement services to property owners. Similarly, it would be beneficial to service providers to have a knowledgeable real estate professional promote the property improvement services. Therefore, it would be desirable to have a real estate professional who's training in home improvement services was recognized by certification. It would also be advantageous to the property owner to avoid the financial burden of carrying out the improvements before selling, as well as having a one-stop shopping for the property improvement services.

### SUMMARY OF THE INVENTION

The present invention is an improved business method that marries the real estate listing process with property improvement services to enable the property seller to sell an improved property without bearing the costs of the improvement. In one exemplary embodiment, the method utilizes two agreements: a listing agreement between the property seller and a listing broker and an agreement between the property seller and a home improvement funding source (referred to herein as the “home improvement loan agreement”).

Another exemplary embodiment utilizes three agreements: the listing agreement between the property seller and the listing broker, an agreement between the property seller and the home improvement funding source, and an agreement between the property seller and the property improvement service provider. In one exemplary embodiment, the property improvement service and the home improvement funding source are the same entity or market their mutual services together to the property seller. For example, the property improvement service provider might have an exclusive contract agreement with the home improvement funding source.

In another exemplary embodiment, a particular real estate professional may have an association with either the home improvement funding source and/or the property improvement service. This association may be exclusive in that the real estate professional agrees to only promote the services of one particular home improvement funding source and/or property improvement service and the home improvement funding source and/or property improvement service may only promote the services of a particular real estate professional.

### BRIEF DESCRIPTION OF THE DRAWINGS

FIG. 1 is a block diagram that illustrates the general legal relationship of the parties according to one exemplary embodiment of the present invention;

FIG. 2 is a block diagram that illustrates a specific example of the legal relationship of the parties according to one exemplary embodiment of the present invention;

FIG. 3 is a block diagram that illustrates the legal relationship of the parties according to another exemplary embodiment of the present invention; and

FIG. 4 is a flow chart that illustrates the process and business method in an exemplary embodiment of the present invention.

### DETAILED DESCRIPTION OF THE INVENTION

The detailed description of exemplary embodiments of the invention herein makes reference to the accompanying figures, which show the exemplary embodiment by way of illustration. While these exemplary embodiments are described in sufficient detail to enable one skilled in the art to practice the invention, it should be understood that other embodiments may be realized, and that changes may be made without departing from the spirit and scope of the invention. Thus, the detailed description herein is presented for purposes of illustration only and not by way of limitation.

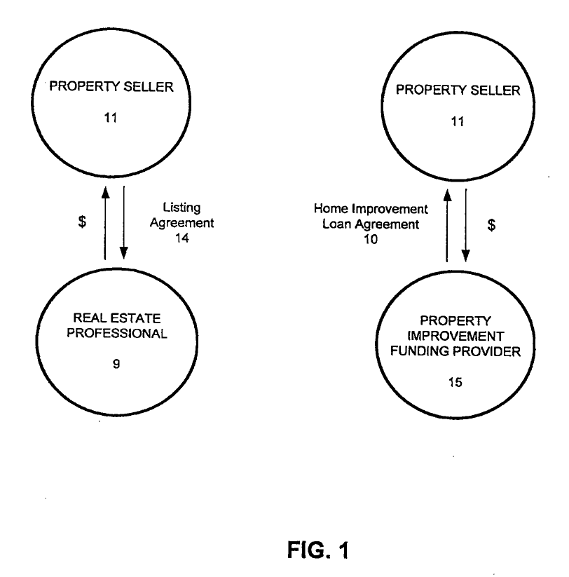

The present invention is a method in which a property seller 11 enters into various agreements in order to improve and sell her property without bearing the financial burden of improving it. For example, the agreements might include a standard listing agreement 14, as is known in the art or something similar, between the property seller 11 and a real estate professional 9 and a home improvement loan agreement 10 between the property seller 11 and a property improvement funding source 15 (e.g. a credit company). FIG. 1 illustrates the general legal relationship of the parties. The arrows indicate a general legal liability to the other. The arrows labeled with the dollar signs point to the party to whom money is paid and the arrows labeled with agreement name point to the party to whom the service is provided. Written agreements are preferred, but oral contracts may suffice if such oral agreements are binding in the applicable jurisdiction. The agreements of the present invention could be combined into a single legal instrument requiring representative signatures from each party.

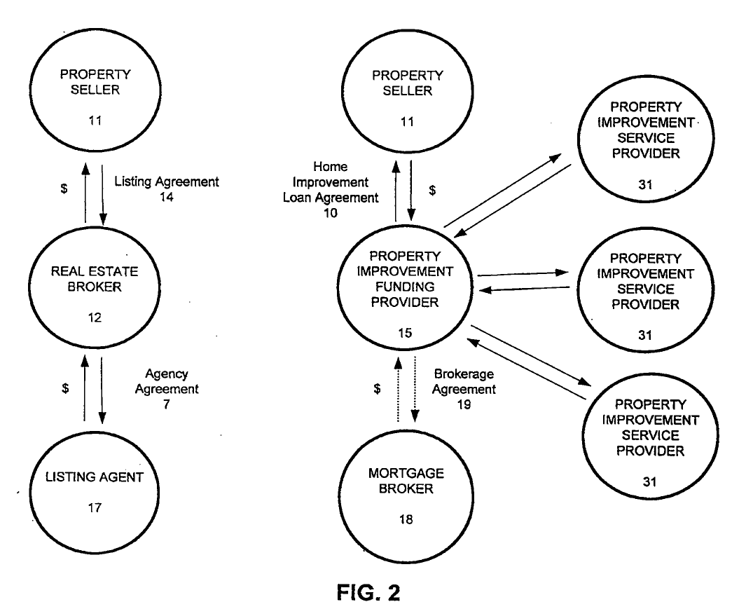

FIG. 2 illustrates a specific example of the legal relationship of the parties in one exemplary embodiment. The property seller 11 enters into two primary agreements: the listing agreement 14 and a home improvement loan agreement 10. The listing agreement 14 may be between the real estate broker 12 and the property seller 11. A listing agent 17 may be specified in the listing agreement 14. Pursuant to an agency agreement 7, the broker 12 will pay to the listing agent 17 a portion of the sales commission received when the property sells.

The home improvement loan agreement 10 is between the property improvement funding source 15 and the property seller 11. The entity may be informal or formal, such as a partnership, limited liability company, or corporation. The funding source 15 will provide the necessary funds for the property seller 11 to conduct necessary improvements. The funding source 15 may also utilize the services of a licensed mortgage broker 18 pursuant to a brokerage agreement 19. This is particularly useful in jurisdictions in which a real estate professional 9 may not collect compensation for rendering services in negotiating mortgage loans unless the real estate professional 9 has a mortgage broker's license or is an employee, officer or partner of a corporation or partnership which holds a mortgage broker license.

Upon execution of the listing agreement 14 and the home improvement loan agreement 10, the funding source 15 assesses the property's condition and informs the seller 11 of a dollar amount the funding source 15 is willing to fund for the specific improvements identified in an improvement proposal. Preferably the proposal is provided in writing. The home improvement loan agreement 10 may be expressly contingent on the property seller's 11 acceptance of the funding source's 15 improvement proposal in this exemplary embodiment. In one exemplary embodiment, the home improvement loan agreement 10 gives the property seller 11 a limited time to the period to accept the improvement proposal. If the property seller 11 does not sign an acceptance of the improvement proposal, the home improvement loan agreement 10 may be automatically cancelled, and the property seller 11 would proceed only under the listing agreement 14.

If the property seller 11 signs an acceptance of the improvement proposal, formal loan documents are prepared, typically by a title company. Generally, the documents comprise a promissory note and a deed of trust. The initial term of the loan may be short, for example 6 months, and the initial interest rate is preferably low, preferably 0% interest to the property seller, but, in any event typically less than the prime rate. The promissory note may require the property seller 11 to use the loan proceeds solely for those improvements identified in the improvement proposal. The deed of trust can be recorded against the subject property in the amount of the loan as is known in the art. The loan will be payable upon successful close of escrow of the property (which constitutes a sale of the property), termination of the listing agreement 14, or at the end of the initial term in this exemplary embodiment. The funding source 15 may extend the initial term of the loan at a minimal interest rate such as prime plus 1%.

In one exemplary embodiment, the funding source 15 will be associated with a property improvement service provider 31. The association may be formal or informal and can comprise a joint venture, a partnership, membership in a limited liability company, or one entity may be a division of another (i.e. the funding source 15 could be a division or a parent company that acts as the property improvement service provider). For example, the property improvement service provider 31 may offer funds directly to the property seller 11 and therefore act as funding source 15. In this exemplary embodiment, the property improvement service provider 31 could comprise a home improvement company or retail store that offers home improvement products and services. The property improvement service provider 31 could have a division that loans money to property sellers 11 for staging the home or other general home improvement. In this exemplary embodiment, property improvement service provider 31 could have a representative visit the property seller 11 at the home being sold. The representative could then view the property and suggest certain improvements (all of which could be purchased and installed from the property improvement service provider 31) and discuss the amount needed to fund the repairs or renovations. Further, since the property improvement service provider 31 and the funding source 15 are one in the same, the representative could discuss the financing terms with the property seller 11 with more knowledge than if the property improvement service provider 31 and funding source 15 were not associated.

The listing agent 17 or other real estate professional 9 could suggest one or more property improvement service providers 21 to the property seller 11, but the seller may choose her own property improvement service providers 31 in an exemplary embodiment. Under appropriate circumstances, considering issues such as ways to improve the property, the interests of the property seller 11, ways to increase the value of the property, etc., exemplary property service providers 31 may comprise interior designers, electricians, landscapers, painters, repairmen, floor installers, glazers, masons, carpenters, plumbers, etc. Other property service improvement service providers comprise, but aren't limited to, a zoning attorney; an architect; or telephone, sewer, cable, electricity or other utility provider.

The property seller 11 selects one or more property improvement service providers and makes the property available for the work to be performed in a timely manner. The funding source 15 will hold the loan funds or, alternatively, deposit the loan funds with the title company that prepares the loan documents. The funding source 15 will do a post-completion inspection of each property improvement service provider's 31 work prior to disbursing funds to the property improvement service provider 31. In an exemplary embodiment where the funding source 15 and property improvement service provider 31 are associated, any modifications requested by the funding source 15 can be quickly and easily accomplished by the property improvement service provider 31.

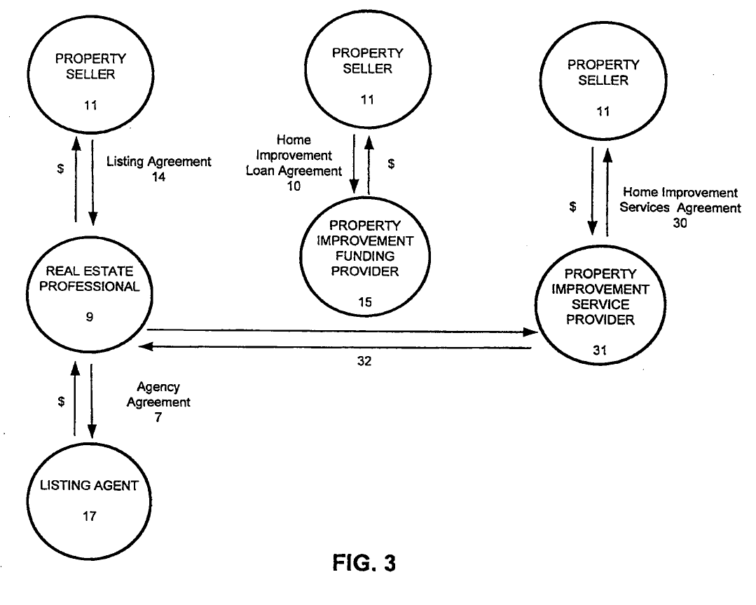

In another exemplary embodiment, an express relationship between the real estate professional 9 and a property improvement service provider 31 and/or funding source 15 may be present. See FIG. 3. Exemplary relationships between the real estate professional 9 or listing agent 17 and property improvement service provider 31 and/or funding source can be informal or formal such as a partnership, co-venture, membership in a limited liability or any other type of business relationship now know or developed in the future. The real estate professional 9 offers to promote the services of at least one property improvement service provider 31 in exchange for the property improvement service provider 31 promoting the services of the particular real estate professional 9. Preferably, the agreement is exclusive between the parties, meaning that the real estate professional 9 will not promote the services of another property improvement service provider 31 and the property improvement service provider 31 will not offer services through another real estate professional 9. If an exclusive agreement like this is in place, any listing agents 17 working with the real estate professional 9 will also promote the services of the home improvement service provider 31 and/or funding source 15.

If the offer is accepted, a promotion agreement 32 may formed between the real estate professional 9 and the home improvement service provider 31. The property improvement service provider 31 is paid by the property seller 11 for the improvement services and materials from funds provided by the property improvement funding source 15.

Before, after, or concurrent with forming the promotion agreement 32 and upon execution of the listing agreement 14 and the home improvement loan agreement 10, the process follows essentially the same steps as noted above. The funding source 15 assesses the property's condition and informs the seller 11 of an amount the funding source 15 may be willing to fund for the specific improvements identified in an improvement proposal. In this exemplary embodiment, the home improvement loan agreement 10 may be expressly contingent on the property seller's 11 acceptance of the funding source's 15 improvement proposal. If the property seller 11 does not accept the improvement proposal, the home improvement loan agreement 10 is automatically cancelled.

If the property seller 11 signs an acceptance of the improvement proposal, formal loan documents are prepared. The initial term of the loan may be short, for example 6 months and at 0% interest to the property seller. The loan will be payable upon sale of the property, termination of the listing agreement 14, or at the end of the initial term.

The real estate professional 9 suggests one or more of the contracted property improvement service providers 31 which may or may not have an association with funding source 15. The property seller 11 selects one or more property improvement service providers 31 and makes the property available for the work to be performed in a timely manner. The funding source 15 will conduct a post-completion inspection of each service provider's 31 work prior to disbursing funds, with the funds being disbursed directly to the property improvement service providers 31.

In these exemplary embodiments, once the parties are in agreement, the next phase is to ready the property for sale, list it, and sell it. In this phase, the licensing agent lists the property seller's 10 property, preferably in the multiple listing service (MLS), as is known in the art. The service provider improves the property, although commonly the actual work is done by a third party, such as an electrician subcontracted to a general contractor. Improvements include the service provided and necessary materials. For example, if the windows need to be updated, the cost will include the cost of the materials and installation thereof. For interior design, the materials may include furniture, art, and other movable property within the home.

The funding source 15 pays the property improvement service provider 31 directly for improvements, sometimes in advance of the work or making payments as work is completed. A certain portion may be held back until the work is completed to satisfaction. The timing of the listing as well as paying for and doing the improvements may vary, depending on the availability of each party and materials, negotiating leverage, and practicalities of getting multiple things done at about the same time. In one exemplary embodiment, the property is improved before it is listed, but the property may be listed before the improvements are complete in another exemplary embodiment.

The sale phase involves the actual sale of the property. The buyer buys the property from the property seller 11 and pays the property seller 11 for the property. In practice, the money may be paid through a third party, such as the title company. The broker is paid her commission and pays the licensing agent her portion. The funding source 15 is reimbursed for costs of improvements.

In one exemplary embodiment, real estate professional 9 or individual listing agents 17 can gain a certification from a particular promoter of the business method of the present invention. By gaining certification, the real estate professional 9 can better promote her services to prospective clients. Moreover, in one exemplary embodiment, certain promotional materials and supplies are only available to individuals or entities that have been certified in the manner set forth herein. In certain embodiments, certification may be only available to real estate professionals 9 who have met certain criteria such as working in real estate full time as opposed to part time or based on past sales success.

Through the certification process, the real estate professional 9 learns about what types of renovations should be performed for certain types of properties. This helps train the real estate professional 9 to maximize the benefits of the method of the present invention and prevents “over improving” a property, having the wrong kind of work performed, or poorly staging the house. For example, a swimming pool is typically an expensive improvement and may be an excellent use of money provided by funding source 15 or not depending on the area where the property is located and the type of buyers that are expected to consider purchasing the property.

Properties in areas that attract buyers who consist of families with children over the age of ten may be highly persuaded by the addition of the new swimming pool making it advantageous to use money from funding source 15 to put in a pool at the property being prepared for sale. However, a swimming pool may be a poor use of the funds from funding source 15 if the property is located in an area that primarily attracts buyers who are older and retired and do not wish to have a home with a swimming pool because of the upkeep. Alternatively, a swimming could also be a liability to the home's sale if it is located in an area that attracts younger buyers with small children who may wish to avoid properties with pools due to the drowning hazard they pose.

The certification process would train real estate professionals 9 to recognize these issues and prevent mistakes and misuse of loaned money from funding source 15. This exemplary certification process may be helpful to real estate professionals 9 and listing agents 17 who are new to the business or do not have a great deal of experience in home renovation or remodeling. This helps maximize the benefit of the loaned money and the return by ensuring a quicker sale for the highest price.

In one exemplary embodiment, the certification process may be completed by a listing agent 17 or real estate professional 9 completing a series of classes or courses to gain certification. To prove their certified status, the course provider may present the real estate professional 9 or listing agent 17 with a certificate, plague, statue or other similar symbol upon being certified. Additionally, the certification may be evidenced by use of a symbol or other mark to denote that a particular real estate professional 9 or listing agent 17 is certified similar to the CRS® collective membership mark owned by the National Association of Realtors indicating that a particular real estate agent is a “certified residential specialist”. In one exemplary embodiment, the certification courses are available online. In other exemplary embodiments, the courses are taught in traditional classrooms.

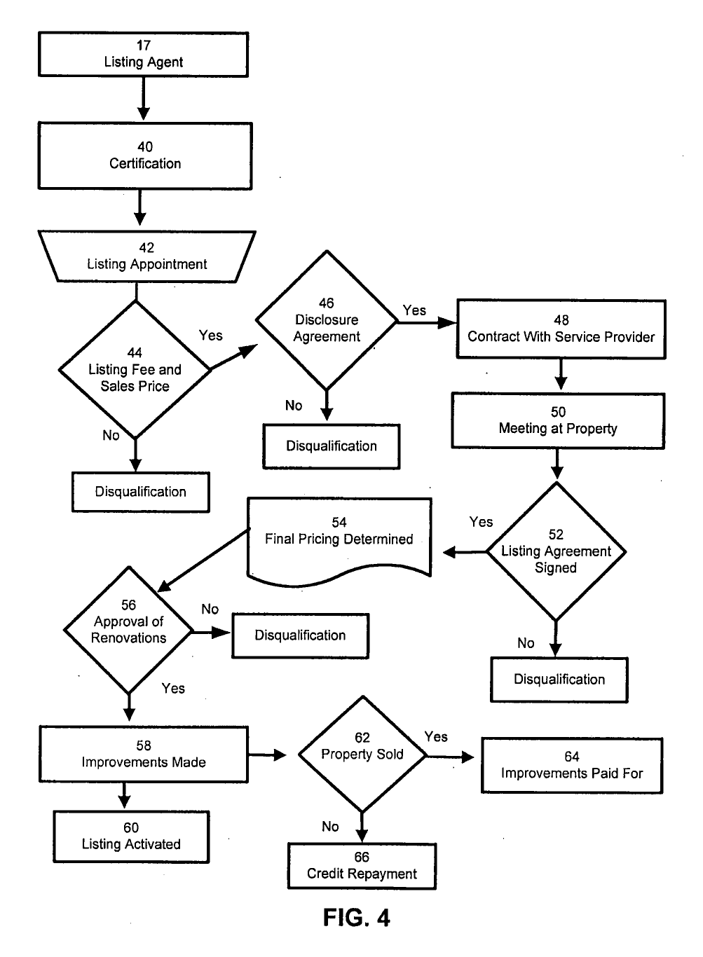

FIG. 4 provides a flow chart that illustrates the method of the present invention in one exemplary, non-limiting embodiment. As shown, the listing agent 17 gains certification at step 40 as explained above. Next, listing agent 17 goes on a listing appointment at step 42 to explain her services and the advantages of remodeling the property seller's 11 home prior to sale. At step 44, property seller 11 either agrees to the listing fee and selling price or not. If no agreement is formed, the property seller 11 is disqualified from the program.

However, if an agreement is formed between the listing agent 17 and property seller 11 at set 44 the next step is for the property seller 11 to authorize an agreement that sets forth the listing process and method of the present invention at step 46. The agreement signed at step 46 is designed to comply with any applicable disclosure statutes for the jurisdiction where the property being sold is located. The disclosure relates to terms of the loan from funding source 15 and the construction process and the risks associated with the renovation including delays and unexpected costs. If the property seller refused to agree to the terms in the agreement at step 46, she is disqualified from the method.

Acquiescence to the agreement at step 46 leads to step 48 whereby the listing agent contacts the property improvement service provider 31. In this exemplary embodiment, the property improvement service provider 31 also acts as funding source 15. At step 48, the listing agent 17 contacts a representative of property improvement service provider 31 and schedules a meeting to review the property being sold.

The meeting between the representative from the property improvement service provider 31, property seller 11, and listing agent 17 takes place at the property being sold in this exemplary embodiment at a step 50. During this meeting, the scope of the renovations is discussed and finalized and the property seller 11 is provided with a written estimate for the work needed.

The next step in the method is a step 52 whereby the property seller 17 signs a listing agreement with the listing agent 17 or other real estate professional 9. If the property seller 11 does not sign the listing agreement, she is disqualified from this method. Signing the listing agreement leads to a step 54 which is finalization of pricing the renovation plans by the property improvement service provider 31.

The next step is a step 56 whereby the property seller 11 agrees to the renovation services provided by property improvement service provider 31 and funding from funding source 15. In this exemplary embodiment, since the property improvement service provider 31 and funding source 15 are one in the same, step 56 is easily accomplished in a single agreement that sets forth the terms for the renovation and loan. Obviously, property seller's 11 failure to agree to the terms at step 56 leads to disqualification.

The property improvement service provider 31 completes the renovations or other improvement services at a step 58. Following successful improvements at step 58, the listing is activated for the property at a step 60. By “activation”, the listing is made available on the MLS, advertised in newspapers and the Internet, and other forms of real estate promotion take place to promote the property to perspective buyers.

At a step 62, the property is either sold or not. If the property is sold at step 62, the property improvement service provider 31 is paid at the closing of sale as described above at a step 64. If the property is not sold at step 62, credit repayment terms are initiated at a step 66 pursuant to the agreement between the property seller 11 and property improvement service provider 31 that was made at step 54.

To better illustrate other exemplary embodiments of the improved method, a non-limiting example is provided of the staging and resale of a home. In this example, the owner of a 2500 square foot house of traditional architecture decides to sell her home since her children have moved out and she wants to buy a small patio home. The house is in a desirable location, but the decor, while being very stylish when in was first decorated in 1970, is now in need of updating. Taking into account the metallic wallpaper, avocado green kitchen appliances, and other signs of the '70's, the house is appraised at $150 per square foot, giving an appraised value of $375,000. The seller contacts a listing agent familiar with the area who knows that, if decorated and furnished in a more current style, the house would sell for $200 per square foot, or $500,000. However, the seller does not have enough cash to pay for the down payment on her patio home and for redecorating the house at the same time. The listing agent and the seller agree that the listing agent will list the house in exchange for a standard 3.5% commission and pay to redecorate the house in exchange for eventual reimbursement for the costs once the house sells.

The listing agent contacts one of the interior designers he knows who agrees to redecorate the house and be paid by the real estate agent. The listing agent introduces the interior designer to the seller. The interior designer and the seller agree that the interior designer will redecorate and furnish the house. Over the next six weeks, the interior designer spends $50,000 decorating the house, paid for by the real estate agent. The listing agent promptly lists and sells the renovated house for $500,000. Of the $500,000 sales price, the agent gets $17,500 in commission and $50,000 reimbursement for the cost of the improvements paid to the interior designer. The standard commission on a $375,000 sale would have been $13,125, so the agent received $4375 more in commission using the present method. The balance of $432,500 goes to the seller, giving her $57,500 more than she would have received less than two months earlier, at no additional financial burden or effort to her and, the buyer is happy with her redecorated home that he put no effort into.

In another non-limiting example, the owner of a 2500 sq ft. house of traditional architecture decides to sell her home. The house is in a desirable location, but the house has not been maintained well since it was built and has fallen into a state of sad disrepair; it is in need of complete renovation. Taking into account the need for new electrical wiring, a new roof, new windows and landscaping, the house appraises at $110 per square foot, giving an appraised value of $275,000. The seller contacts a listing agent familiar with the area who knows that, in this area, if the home were completely renovated, including adding a pool and a covered garage, the house would sell for $200 per sq. ft., or $500,000. However, as apparent from its current state, the seller does not have enough knowledge or cash to renovate the home. The listing agent and the seller agree that the listing agent will list the house in exchange for a standard 3.5% commission and will have the listing agent's company pay to have the house renovated for a fee of $150,000 to be reimbursed out of the proceeds of the sale.

The listing agent's company hires a general contractor to renovate the house, including replacing the electrical wiring, roof, and windows and adding a landscaped pool and a covered garage. Over the next three months, the general contractor spends $125,000 renovating the house, paid for by the listing agent's company. The listing agent promptly lists and sells the renovated house for $500,000. Of the $500,000 sales price, the agent gets $17,500 in commission and $150,000 fee for renovation. The standard commission on a $275,000 sale would have been $9625, so the agent received $7885 more in commission using the present method. Since the cost of renovation was $25,000 less than the fee charged, the agent made an additional $25,000 more using this method. The balance of $332,500 sales price goes to the seller, giving her $57,500 more than he would have received less than two months earlier, at no additional financial burden or effort to her. And, again, the buyer is happy with her redecorated home that he put no effort into.

The present invention provides three primary benefits to the sellers: (1) no out-of-pocket expenses; (2) potentially higher net sales proceeds; and (3) potentially faster sale of their properties. The method enables the property seller to sell an improved property without bearing the costs of the improvement. The other parties benefit, too. A service provider benefits because it is provided with more work. A listing agent benefits because the chances of selling the property, and the chances of selling the property sooner and at a higher price, all increase. A broker benefits because the added benefits increase the number of properties listed.

The present invention may be described herein in terms of various components and processing steps. Further, it should be appreciated that while the description above has dealt almost exclusively with residential real estate, the method of the present invention could also be applied to commercial real estate including sales and leases of commercial property. Therefore, the scope of the present invention is not intended to be limited by this description but rather by the following claims.

1. A method of selling property comprising:
a) forming a listing agreement between a real estate professional and a property seller;
b) forming a home improvement loan agreement for a loan between the property seller and a home improvement funding source;
c) improving the property using funds from the home improvement funding source;
d) listing the property;
e) selling the property to a buyer for a given sum; and
f) distributing the given sum in part to the home improvement funding source as repayment of the loan; such that the property seller sells an improved property without bearing the costs of the improvement.

2. The method of claim 1 further comprising a property improvement service provider that is associated with the home improvement funding source.

3. The method of claim 2 wherein the real estate professional is a real estate brokerage.

4. The method of claim 2 wherein the real estate professional is a real estate broker.

5. The method of claim 2 wherein the real estate professional is a real estate agent.

6. The method of claim 2 wherein the home improvement loan agreement has an initial term and an initial interest rate.

7. The method of claim 6 wherein the loan will be due upon sale of the property, termination of the listing agreement, or at the end of the initial term.

8. The method of claim 6 in which the initial term of the loan is for six months or less.

9. The method of claim 6 in which the initial interest rate of the loan is less than the prime rate.

10. The method of claim 2 further comprising providing an improvement proposal to the property seller from the real estate professional.

11. The method of claim 10 in which the loan comprises a promissory note and a deed of trust and the promissory note requires the property seller to use the loan for improvements identified in the improvement proposal.

12. The method of claim 2 further comprising forming a home improvement services agreement between the property seller and the property improvement service provider.

13. A method of selling property comprising:
a) forming a listing agreement between a real estate broker and a property seller, wherein the listing agreement specifies a listing agent who receives a commission upon the sale of the property;
b) forming a home improvement loan agreement for a loan between the property seller and a home improvement funding source;
c) forming a home improvement services agreement between the property seller and a property improvement service provider;
d) improving the property;
e) listing the property;
f) selling the property to a buyer for a given sum; and
g) distributing the given sum in part to the listing agent for commission and to the home improvement funding source as repayment of the loan; such that the property seller sells an improved property without bearing the costs of the improvement.

14. The method of claim 13 wherein the property improvement service provider is the home improvement funding source.

15. The method of claim 14 wherein the loan will be due upon sale of the property, termination of the listing agreement, or at the end of the initial term.

16. The method of claim 14 in which the initial term of the loan is for six months or less.

17. The method of claim 14 in which the initial interest rate of the loan is less than the prime rate.

18. The method of claim 13 wherein the property improvement services provider and home improvement funding source are associated.

19. The method of claim 18 wherein the association between the property improvement service provider and home improvement funding source is a partnership.

20. The method of claim 18 wherein the association between the property improvement service provider and home improvement funding source is a joint venture.

21. The method of claim 18 wherein the association between the property improvement service provider and home improvement funding source is that the property improvement service provider is a parent company of the home improvement funding source.

22. The method of claim 13 further comprising forming at least one promotional agreement between the home improvement funding source and at least one property improvement service provider.

23. The method of claim 22 in which the promotional agreement is exclusive.

25. A method of selling property comprising:
a) forming a listing agreement between a real estate broker and a property seller, wherein the listing agreement specifies a listing agent who receives a commission upon the sale of the property;
b) forming an agreement with a third party that acts as a home improvement funding source and a property improvement service provider;
d) improving the property;
e) listing the property;
f) selling the property to a buyer for a given sum; and
g) distributing the given sum in part to the listing agent for commission and to the third party that acts as a home improvement funding source and property improvement service provider.

26. The method of claim 25 wherein the entity that acts as a home improvement funding source and property improvement service provider operates retail outlets.

27. The method of claim 26 wherein the retail outlets are dedicated to home improvement.

29. A method of selling property comprising:
a) providing a trained a real estate professional in renovating and preparing properties for sale who has been certified in renovating and preparing properties;
b) forming a listing agreement between the real estate professional and a property seller;
c) forming an agreement between the property seller and a property improvement service provider wherein the property improvement service provider also acts as a home improvement funding source;
d) loaning a given sum of money from the home improvement funding source to the property seller;
e) improving the property using funds from the loan given by the home improvement funding source;
f) listing the property for sale;
g) selling the property to a buyer for a given sum; and
h) repaying the loan provided by the home improvement funding source with funds generated by the sale of the property after the property is sold.

30. The method of claim 29 wherein the real estate professional is a real estate agent.

31. The method of claim 29 wherein the real estate professionals who have been certified denote the certification status with a trademark.

32. A method of selling property comprising:
a) providing a property improvement service provider who acts as a funding source;
b) forming a contract between the property improvement service provider and a property seller whereby the property improvement service provider agrees to improve a property owned by the property seller for a given sum of money; wherein
c) the given sum of money is loaned by the property improvement service provider to the property seller and payment on the loan is not due until either the property seller sells the property or cancels an agreement with a third party.

33. The method according to claim 32 wherein the third party is a real estate professional.

34. The method according to claim 32 wherein the agreement is a listing agreement.

35. The method according to claim 32 wherein property improvement service provider operates retail outlets.
